(19) United States
(12) Patent Application Publication
(10) Pub. No.: US 2009/0077325 A1
(43) Pub. Date: Mar. 19, 2009

(54) Method and arrangements for memory access

(75) Inventor: Andjelija Savic, Beograd (YU)

Correspondence Address: Alan Carlson, 6202 Lynn Lane, Lago Vista, TX, 78645, US

(73) Assignee: On Demand Microelectronics

(21) Appl. No.: 11/901,795

(22) Filed: Sep. 19, 2007

(51) Int. Cl. G06F 12/00

(52) U.S. Cl. 711/151; 711/E12.001

(57) ABSTRACT

In one embodiment a memory system is disclosed having a first requester group, a first access control module coupled to the first requester group to receive access requests from the first requester group, a second requestor group and a second access control module coupled to the second requestor group to receive access requests from the second requestor group and memory. The memory can be segmented into a plurality of address blocks, where the plurality of address blocks can have an address range. The controller can sequentially rotate write access among the plurality of address blocks to distribute the sequential data among the plurality of address blocks.

### FIELD

This disclosure relates to memory for parallel processing units and to methods and arrangements for accessing multi-ported memory with a parallel processor architecture.

### BACKGROUND

Typical instruction processing pipelines in modem processor architectures have several stages that include a fetch stage, a decode stage and an execute stage. The fetch stage can load memory contents, possibly instructions and/or data, useable by the processors. The decode stage can get the proper instructions and data to the appropriate locations and the execute stage can execute the instructions. Concurrently, data required by the execute stage can be passed along with the instructions in the pipeline. In some configurations, data can be stored in a separate memory system such that there are two separate memory retrieval systems, one for instructions and one for memory. In a system that utilizes very long instruction words, the decode stage can expand and split the instructions, assigning portions or segments of the total instruction word to individual processing units and can pass instruction segments to the execution stage.

One advantage of instruction pipelines is that a complex process can be broken up into stages where each stage is specialized in a function and each stage can execute a process relatively independently of the other stages. For example, one stage may access instruction memories, one stage may access data memories, one stage may decode instructions, one stage may expand of instructions and a stage near the execution stage may analyze whether data is scheduled or timed appropriately and sent the correct location. Each of these processed can be done concurrently or in parallel. Further, another stage may write the results created by executing an instruction back to a memory location or a register. Thus, all of the abovementioned stages can operate concurrently.

Accordingly, each stage can perform a task, concurrently with the processor/execution stage. Pipeline processing can enable a system to process a sequence of instructions, one instruction per stage concurrently to improve processing power due to the concurrent operation of all stages. In a pipeline environment, in one clock cycle one instruction or one segment of data can be fetched by the memory system, while another instruction is decoded in the decode stage, while another instruction is be executed in the execute stage.

In a non-pipeline environment, one instruction can require numerous clock cycles to be executed/processed (i.e. one clock cycle to achieve each of a retrieve/fetch, decode and execute process). However, in a pipeline configuration while one instruction is being processed by one stage, others stages can be concurrently load, decoding and process data. This is particularly important because a pipeline system can fetch or “pre-fetch” data from a memory location that takes a long time to retrieve such that the data is available at the appropriate time and the pipeline will not have to stall and/or wait for this “long lead time” data. However, traditional data retrieval systems do not efficiently load processors of a pipeline, creating considerable stalling as the execute stage waits for the required data.

### SUMMARY OF THE INVENTION

In one embodiment a memory system is disclosed having a first requestor group, a first access control module coupled to the first requester group to receive access requests from the first requester group, a second requester group and a second access control module coupled to the second requester group to receive access requests from the second requestor group. The system can also include a controller module coupled to the first and second access control module to prioritize the access requests from the first and second requestor group, and memory coupled to the controller module. The memory can be segmented into a plurality of address blocks, where the plurality of address blocks can have an address range. The controller can sequentially rotate write access among the plurality of address blocks to evenly distribute data that is adjacent in sequential data among the plurality of address blocks. Thus, data segments that are adjacent in the data stream (sequential data) will be separated by a predetermined number or address locations in memory when stored by the system. This allows different processors that are accessing adjacent pixel data to access memory locations that are far enough apart such that a memory access controller can control the memory locations during the same clock and retrieve the “adjacent pixel data” in a single clock cycle because different control and bus lines retrieve the data.

In other embodiments the controller module can control a single access per clock cycle to an address block in the plurality of address blocks. Further, at least one address block can be written to by the first requestor group when the at least one address block is unrequested by the second requestor group. There can be m requestor groups where each requestor group can include k accessors and k access control modules, where each of the k access control modules can control access to m address blocks, and the memory can have k*m address blocks.

In some embodiments a method is disclosed that can include segmenting a memory into a plurality of address blocks, accepting requests from a plurality of requesters, the requests to store sequential pixel data (and other data types), parsing the sequential pixel data into segments; and storing the segments by rotating the address blocks utilized to store sequential data segments. The method can also include prioritizing the storage requests based on the requestor group that has issued the request. The plurality of requestors can utilize a same instruction multiple data configuration. In some embodiment the method can detect when a segment of addresses will be in use by an accessor and control accesses to the memory based on the detection.

In other embodiments a computer program product is disclosed. The computer program products can include a computer useable medium having a computer readable medium, wherein the computer readable medium when executed on a computer can cause the computer to segment a memory into a plurality of address blocks wherein blocks have an address range accept requests from a plurality of requesters. The requests can be requests to access sequential data. The product when executed can parse the sequential data into segments and store the segments by sequentially rotating the use of address blocks. Also when executed, the medium can cause the computer to prioritize the storage requests based on which group is requesting access.

### BRIEF DESCRIPTION OF THE DRAWINGS

In the following the disclosure is explained in further detail with the use of preferred embodiments, which shall not limit the scope of the invention.

FIG. 1 is a block diagram of two multi-port access control modules that can access a memory cell module having four ports;

FIG. 2 is a block diagram of a processor architecture having parallel processing modules;

FIG. 3 is a block diagram of a processor core having a parallel processing architecture;

FIG. 4 is an instruction processing pipeline using a data memory subsystem (DMS) control module;

FIG. 5 is a block diagram of two multi-port access control modules that can access a memory cell module having four ports utilizing two memory cells per control logic module;

FIG. 6 is a block diagram of a multi-port access control modules that can access a memory cell module having four ports with three memory cells per control logic module, whereas the multi-port access control modules have a different number of accessors;

FIG. 7 shows an addressing scheme for a block of memory;

FIG. 8 shows another addressing scheme for a block of memory block; and

FIG. 9 is a block diagram of a five multi-port access control modules that can access a memory cell module having four ports with five memory cells per control logic module, whereas each multi-port access control module can have an arbitrary number of accessors.

### DETAILED DESCRIPTION OF THE PREFERRED EMBODIMENTS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

While specific embodiments will be described below with reference to particular configurations of hardware and/or software, those of skill in the art will realize that embodiments of the present disclosure may advantageously be implemented with other equivalent hardware and/or software systems. Aspects of the disclosure described herein may be stored or distributed on computer-readable media, including magnetic and optically readable and removable computer disks, as well as distributed electronically over the Internet or over other networks, including wireless networks. Data structures and transmission of data (including wireless transmission) particular to aspects of the disclosure are also encompassed within the scope of the disclosure.

In one embodiment, methods, apparatus and arrangements for issuing asynchronous memory requests to multiple requesters or a multi-unit processor that can be executed in very long instruction words (VLIW) s are disclosed. The multi-unit-processor can have a plurality of processing cores/units, an instruction pipeline, a register file, and can access internal and external memories. In some embodiments, methods, apparatus and arrangements for asynchronously handing and distributing of memory access requests among a plurality of memory cells is disclosed. In other embodiments the arranging of data in memory to facilitate parallel processing of streaming data by the parallel processing units is disclosed.

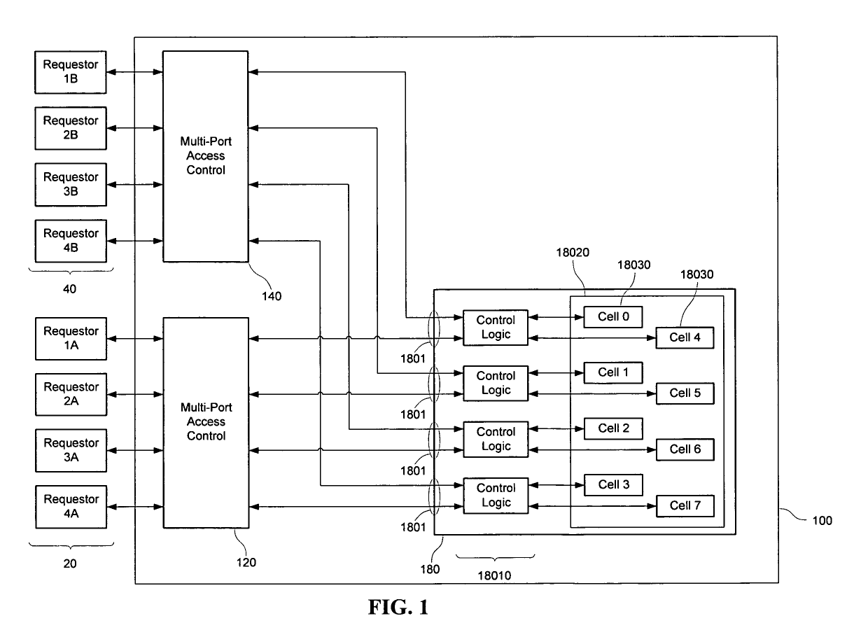

Referring to FIG. 1 a block diagram of a memory control system 100 is disclosed. Processing units such as requestors 20 and 40 can access a memory module 180 via multi-port access control modules 140. Four requestors 20 can be associated with a multi-port access control module 120 and four requesters 40 can be associated with a multi-port access control module 140. Each multi-port access control module 120 and 140 can receive memory requests from the requestors 20 and 40 that are associated. Modules 120 and 140 can route the requests to four ports 1801 of the memory module 180. The disclosed configuration can send up to four requests to the ports at each clock cycle.

Each of the ports 1801 can be associated with a control logic module 18010. Each control logic module 18010 can control access to two memory cells 18030. The number of memory cells 18030 associated with each control logic module 18010 can be equivalent to the number of multi-port access control modules to provide a balanced system. It can be appreciated that two multi-port access control modules 20 and 40 can access the memory module 180 where each multi-port access control module can have four requestors to provide an economic system. Hence, the memory block 18020 can have four times two memory cells. In general, if m is the number of multi-port access control modules, and k is the maximum number of requesters associated with the multi-port access control modules, memory module 180 can run economically with k ports and k control logic modules 18010, where each control logic module 18010 can control m memory cells 18030, and block 18020 can include k*m memory cells 18030 and the memory cells 18030 can be arranged as a matrix of k rows and m columns. A memory cell can have any size, e.g. several kilobytes. However, the sizes of the memory cells in a column must be the same.

Each control logic module 18010 can receive m requests and can route the requests to m cells associated to the module 18010 whereas requests that go to different modules can be routed in parallel and requests that go to the same cell can have to be prioritized and/or queued. As mentioned above, each control logic module 18010 can control access to m memory cells 18030 and each control logic module 18010 can retrievey memory requests per clock cycle through port 1801. In some embodiments, each memory cell 18030 can accept only one request per cycle. Therefore, if more than one memory requests is made for a specific memory cell for a given clock cycle, the requests can be prioritized and one request can be assigned a higher priority and the request with the highest priority can be forwarded to the corresponding memory cell 18030 in a subsequent clock cycle while the other requests(s) can be queued and executed during future clock cycles.

The prioritization and/or the queuing of requests can be performed by the control logic module 18010 or by the multi-port access control modules 20 and 40. The forwarding of memory access requests to the corresponding memory cells 18030 can be performed by the control logic modules 18010. It can be appreciated that during normal operation, up to y memory requests can be executed by a control logic module 18010 per clock cycle because possibly each memory cell 18030 can execute only one request per clock cycle, whereas the control logic module 18010 can forward all up to y requests to the corresponding memory cells 18030. Therefore, the system disclosed can handle k*m memory requests each clock cycle.

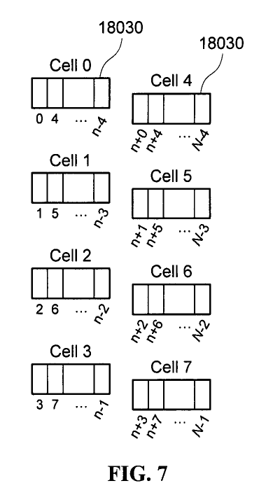

The memory block 18020 can have a continuous memory range from 0 to N. However, the addresses of the memory block 18020 can be distributed over the memory cells 18030. Referring briefly to FIG. 7 a distribution of memory addresses that could be utilized is disclosed. Memory cells 18030 can be segmented into a plurality of address blocks, where the plurality of address blocks can have an address range. The controller 18010 (inconsistent) can sequentially rotates access to the cells 18030 or among the plurality of address blocks such that streaming data or data that is received sequentially can be uniformly distribute among the plurality of address blocks. Thus, under normal operation requesters 20 and 40 will request access to the cells in a uniform manner and concurrent request to access the same cell can be minimized.

The consecutive addresses locations illustrated can be equally distributed over the memory cells. This can make a parallel processing architectures like a SIMD architectures operate more efficiently when data which is arranged sequentially in the memory. One example of sequential data can include pixel data of an image stored in memory. As pixel information of an image is normally is stored sequentially with increasing addresses in the memory, (adjacent pixels in adjacent memory locations) it can be appreciate that the disclosed configuration can locate adjacent pixel data (adjacent in the stream or on the screen) in a staggered fashion with a uniform number of address location between each adjacent pixels. Thus, adjacent pixel data can be located in different memory cells 18030 and this data distribution process can be controlled by different control logic modules 18020.

This arrangement of data in memory can allow, in a typical processing mode, parallel or concurrent access to subsequently stored data by multi-ported access to single-ported memory cells 18030 where the cells together, form a memory block 18020 which can be accessed. Each control logic module 18010 can control m memory cells 18030 and the memory addresses range 0 to N can be broken in to a series of sub-ranges, e.g., the two sub-ranges 0 to n-1 and n to N of FIG. 7. If the multi-port access control modules 18010 access different sub-ranges which lie in different memory cells 18030, accessor groups which are represented by the multi-port access control modules can access the different memory ranges independently from the other accessor group.

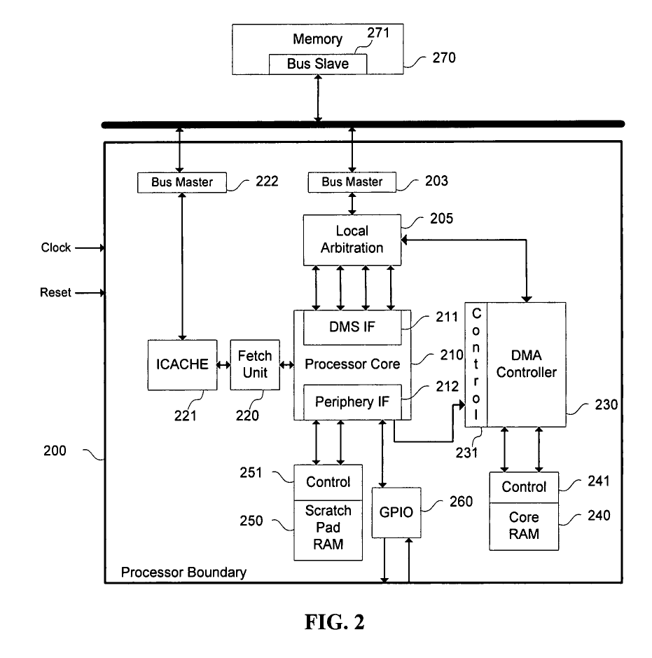

FIG. 2 shows a block diagram of a processor system 200 which could be utilized to process image data, video data or perform signal processing, and control tasks. The processor 200 can include a processor core 210 which can be responsible for computation and executing instructions loaded by a fetch unit 220 which can execute fetch instructions. The fetch unit 220 can read instructions from a memory unit such as an instruction cache memory 221 which can acquire and cache instructions from an external memory 270 over a bus or interconnect network.

The external memory 270 can utilize bus interface modules 222 and 271 to facilitate such an instruction fetch or instruction retrieval. In one embodiment, the processor core 210 can utilize four separate ports to read data from a local arbitration module 205 whereas the local arbitration module 205 can schedule and access the external memory 270 using bus interface modules 203 and 271. In one embodiment, instructions and data can be read over a bus or interconnect network from the same memory 270 but this is not a limiting feature, instead any bus/memory configuration could be utilized such as a “Harvard” architecture for data and instruction access.

The processor core 210 could also have a periphery bus which could be utilized to access and control a direct memory access (DMA) controller 230 via control interface 231. The processor ore can also be assisted by a fast scratch pad random access memory (RAM) via control interface 251. Further, the processor core 210 could communicate with external modules via a general purpose input/output (GPIO) interface 260. The DMA controller 230 can access the local arbitration module 205 and read data from and write data to the external memory 270. Moreover, the processor core 210 can access a fast core RAM 240 to allow faster access to data. The scratch pad memory 250 can be a high speed memory that can be used to store intermediate results or data which is frequently utilized. The fetch and decode stages can be executed by the processor core 210.

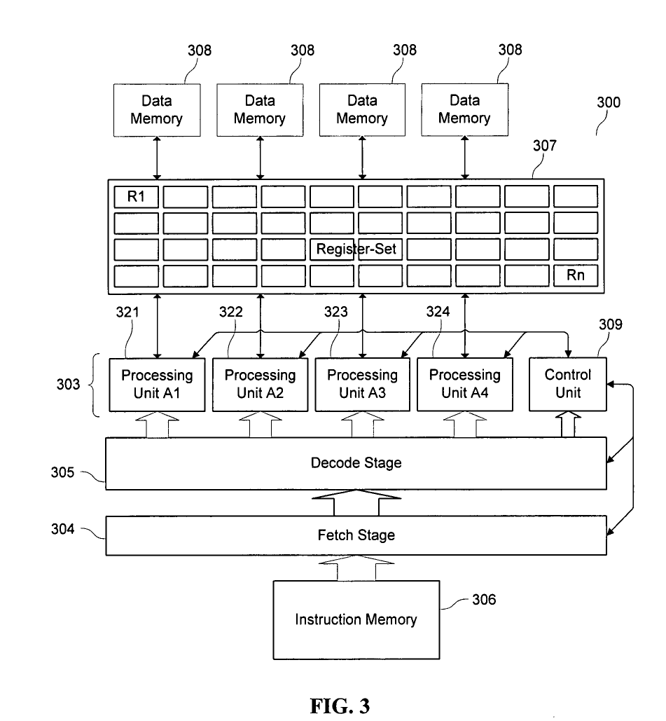

FIG. 3 shows a high-level overview of a processor core 300 which can be part of a processor having a multi-stage instruction processing pipeline. The processor 300 can be used as the processor core 210 shown in FIG. 2. The processing pipeline of the processor core 301 can include a fetch stage 304 to retrieve data and instructions, a decode stage 305 to separate very long instruction words (VLIWs) into units, processable by a plurality parallel processing units 321, 322, 323, and 324 in the execute stage 303. Furthermore, an instruction memory 306, can store instructions and the fetch stage 304 can load instructions into the decode stage 305 from the instruction memory 306. The processor core 301 can contain four parallel processing units 321, 322, 323, and 324. However, the processor core can have any number of parallel processing units.

Further, data can be loaded from, or written to data memories 308 from a register area or register file 307. Generally, data memories can provide data and can save the results of the arithmetic proceeding provided by the execute stage. The program- flow to the parallel processing units 321-324 of the execute stage 303 can be influenced for every clock cycle with the use of at least one control unit 309. The architecture shown provides connections between the control unit 309, processing units, and all of the stages 303, 304 and 305.

The control unit 309 can be implemented as a combinational logic circuit. The control unit 309 can receive instructions from the fetch 304 or the decode stage 305 (or any other stage) for the purpose of coupling processing units for specific types of instructions or instruction words, for example, for a conditional instruction. In addition, the control unit 309 can receive signals from an arbitrary number of individual or coupled parallel processing units 321-324, which can signal whether conditional instructions have been loaded in the pipeline.

The fetch stage 304 can load instructions and immediate values (data values which are passed along with the instructions within the instruction stream) from an instruction memory system 306 and can forward the instructions and immediate values to a decode stage 305. The decode stage 305 can expand and split the instructions and passes them to the parallel processing units.

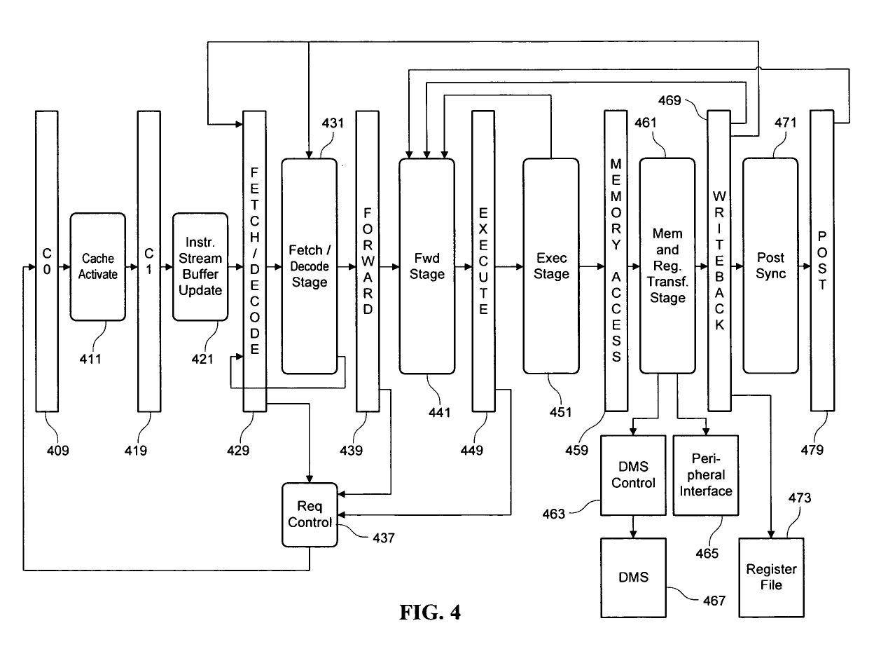

Referring to FIG. 4 pipeline with a processor core 210 such as the one illustrated in FIG. 2 is depicted. The vertical bars 409, 419, 429, 439, 449, 459, 469, and 479 depict pipeline registers. Modules 411, 421, 431, 441, 451, 461, and 471 can read data from a previous pipeline register and may store a result in the next pipeline register. Modules of a pipeline register can form a stage of the pipeline. Other modules may send signals to zero, one, or several pipeline stages, where the stages can be the same stage, a previous stage, or a next pipeline stage.

The pipeline can also include two coupled pipelines. One pipeline can be an instruction processing pipeline which can process the stages between the bars 429 and 479. Another pipeline can be tightly coupled to the instruction processing pipeline and can be an instruction cache pipeline which can process the steps between the bars 409 and 429.

The instruction processing pipeline can consist of several stages which can be a fetch-decode stage 431, a forward stage 441, an execute stage 451, a memory and register transfer stage 461, and a post-sync stage 471. The fetch-decode stage 431 can contain of a fetch stage and a decode stage. The fetch-decode stage 431 can fetch instructions and instruction data, can decode the instructions, and can write the fetched instruction data and the decoded instructions to the forward register 439. Instruction data can be a value which is included in the instruction stream and passed into the instruction pipeline along with the instruction stream. The forward stage 441 can prepare the input for the execute stage 451. The execute stage 451 can consist of a multitude of parallel processing units as explained with the processing units 321, 322, 323, or 324 of the execute stage 303 in FIG. 3. In some embodiments the processing units can access the same register file as it has been explained with respect to the register file 307 of FIG. 3. In other embodiments, each processing unit can access its own or a dedicated register file.

One instruction to be executed by a processing unit of the execute stage can be to load a register with instruction data provided with the instruction. However, for the data to propagate from the execute stage to the register may take several clock cycles. In conventional pipeline design without a so-called “forward functionality”, the pipeline may have to stall until the data is loaded to the register for the processing unit to be able to request this data in a next instruction. Other conventional pipeline designs do not stall in this case but disallow the programmer to query the same register in one or a few next cycles in the instruction sequence.

However, in some embodiments the forward stage 441 can provide data (which will be loaded to registers in one of the next cycles) for instructions that are to be processed by the execute stage. The data can propagate in parallel with the pipeline through modules towards the registers and this parallel piping allows the data to be available quickly.

In one embodiment, the memory and register transfer stage 461 can be responsible to transfer data from memories to registers or from registers to memories. The stage 461 can control the access to one or even a multitude of memories which can be a core memory or an external memory. The stage 461 can communicate with external periphery through a peripheral interface 465 and can access external memories through a data memory sub-system (DMS) 467. The DMS control module 463 can be utilized to load data from a memory to a register and the memory can be accessed by the DMS 467.

A pipeline can process a sequence of instructions simultaneously during a single clock cycle. However, each instruction processed by the pipeline can take several clock cycles to pass through all of the stages. Hence, data can be loaded to a register in the same clock cycle as the instruction in the execute stage requests the data. Therefore, embodiments of the disclosure can have a post sync stage 471 which has a post sync register 479 to hold data in the pipeline when needed. The data can be directed from the register to the execute stage 451 by the forward stage 441 while it is loaded in parallel to the register file 473 as described above.

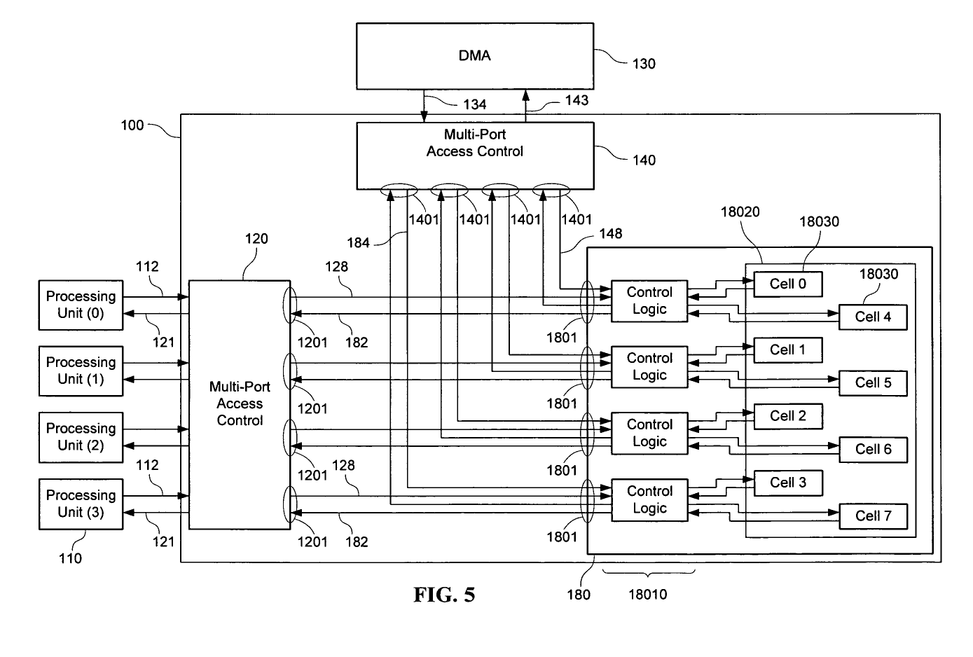

FIG. 5 shows a system 100 that can operate as modules 230, 241, and/or 240 depicted in FIG. 4. A number of parallel processing units 110 can independently access a memory cell module 180 through a multi-port access control module 120. Each parallel processing unit can access, or issue a read or a write request by sending signals 112 to the memory module 180. However, the processing units can independently request access to arbitrary memory addresses of the memory cell module 180 during the same clock cycle. Therefore, the memory cell module 180 can act as a multi-ported memory to the processing units 110. The processing units 110 can be termed an accessor group that uses a multi-port access control module that can have k ports. The multi-port access control module 120 illustrated has four (k=4) ports 1201, however, the system could be scaled to accommodate any number of ports.

A second accessor group is also illustrated that can issue memory requests to the memory cell module 180. The second accessor group could be a direct memory access (DMA) controller 130. A DMA controller 130 can typically perform a DMA-read operation which can read data from an external memory (not shown) and load the data to an internal memory module. Another typical operation can be a DMA-write operation which can include reading data from the internal memory module and writing the data to the external memory. The DMA controller 130 can load data from an external memory (not shown) to the memory cell module 180 and/or can load data from the memory cell module 180 to the external memory.

In some embodiments, the DMA controller 130 can access the memory cell module 180 through another multi-port access control module 140. Therefore, from the memory module 180 point of view the DMA controller 130 can be a second accessor. Similar to module 120 module 140 can use k ports 1401 to access the memory cell module 180. The multi-port access control module 140 can be similar to the multi-port access control module 130, however, the module 140 can communicate with one accessor (the DMA controller 130) and to one module 120 can communicate with a plurality of parallel processing units 110.

A multi-port access control module can schedule, prioritize, and/or sort the incoming requests from a group of accessors, can route and forward the requests to certain ports 1801 of a memory cell module 180, can retrieve information or data associated to the requests from the memory cell module 180 (the so-called request response), and can route the information or data back to the accessor group. In the case of the multi-port access control 120 the accessor can be a plurality of parallel processing units 110 which each can send out requests 112 and can retrieve request responses 121. The multi-port access control 140 may have only one accessor which is the DMA controller 130 which can send out requests 134 and can retrieve request responses 143. The multi-port access control module 140 can also serve up to k ports of the memory cell module 180 whereas each port can enable access to a certain address range of the memory cell module 180.

The memory cell module 180 can have k ports for memory access. Each of the k ports can be accessed by y multi-port access control modules. The memory cell module can comprise of k control logic modules 18010 and a memory block 18020. Each of the k control logic modules 18010 can be associated with one of the k ports and can control m memory cells. The memory block 18020 can comprise of k*m memory cells 18030 where m≧2. In some embodiments, m can be equal to y, however it is to note that m does not have to be equal to m.

The memory cell module 180 of FIG. 5 can have four (k=4) ports 1801. Each of the control logic modules 18010 can control two (m=2) memory cells 18030. Moreover, the memory cell module 180 can have two accessor groups (y=2) which are the processing units 110 and the DMA module 130.

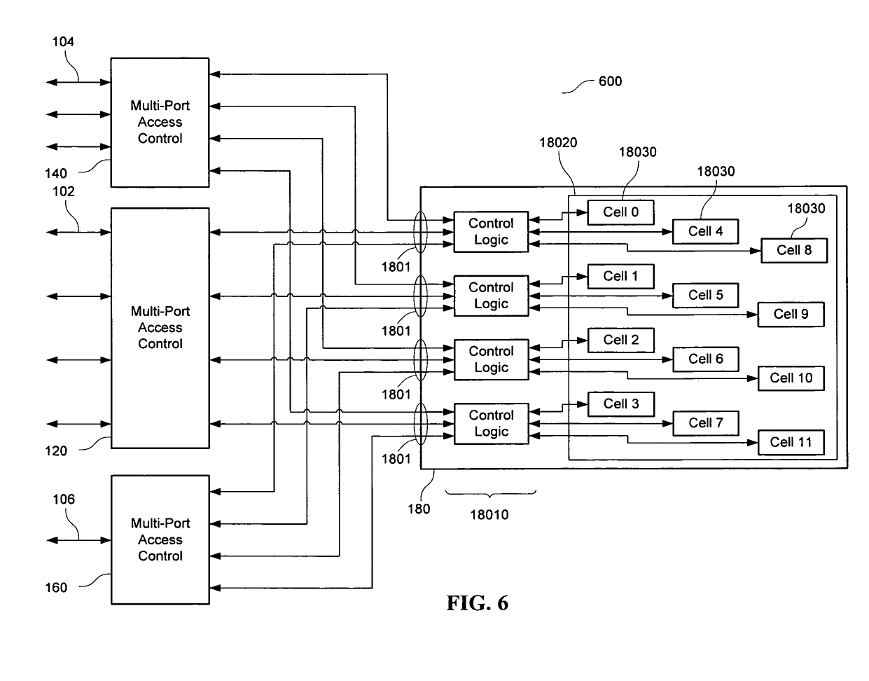

Referring to FIG. 6 a memory cell module 180 that has four (k=4) control logic modules 18010 is depicted. Each memory cell module 180 can be associated with one of the four (k=4) ports 1801. Each control logic module 18010 can control access to three (m=3) memory cells 18030. Moreover, each control module 18010 can enable three (y=3) multi-port access control modules 120, 140, and 160 to access the memory cells 18030. The memory block 18020 can have eight memory cells 18020.

It is to note, that each multi-port access control module can have a different number of accessors. It can be appreciated that multi-port access control module 120 has four accessors that can access module 120 which is illustrated by the four -arrows 102, and module 140 has three accessors illustrated by the arrows 104, and the module 160 has one accessor illustrated by the arrow 106.

A multi-port access control module and the control logic modules 18010 can in combination, control the access of an arbitrary number of accessors to arbitrary addresses in the memory block 18020. However, the memory block 18020 can contain a series of single-ported memory cells 18030 that can be used for any addressing scheme of the address range of the memory block 18020 on principal. In some embodiments, the multi-port memory access control modules and in other embodiments the control logic modules can have request queues which can queue requests that go to the same cell and/or to the same bunch of memory cells 18030 that are controlled by one control logic module 18010.

The advantage of this approach is that single ported memories can be used to create a multi-ported memory whereas each port can have a variety of y different accessor groups, each accessor group represented by a multi-port memory control, each group comprising of an arbitrary number of accessors. Moreover, the multi-port memory control modules and/or the control logic modules can prioritize request based on different criteria. Such a prioritization criteria can be the origin of the request, e.g., requests originated from processor can be assigned higher priority over requests originated from a DMA controller. The memory addresses of the memory block 18020 can be distributed over the memory cells.

Referring to FIG. 7, an addressing scheme for the memory block 18020 of illustrate in FIG. 5 is depicted. The memory block 18020 can include memory cells 18030 that are controlled by control logic modules 18010. Address 0 is in Cell 0, address 1 in Cell 1, address 2 in Cell 2, address 3 in Cell 3, address 4 again in Cell 0, address 5 in Cell 6, and so on. The memory cells 18030 labeled “Cell 0”, “Cell 1”, “Cell 2”, and “Cell 3” can form the address range 0 to n-1 and the memory cells 18030 labeled “Cell 4”, “Cell 5”, “Cell 6”, and “Cell 7” can form the address range n to N-1.

The data storage/address routine illustrated by FIG. 7 can provide for efficient data storage and revival for applications or algorithms that are adapted to store streaming data such as pixel related data in memory where adjacent pixels in a frame or picture are adjacent or consecutive in the data stream. In case of an SIMD (single instruction multiple data) architecture, as explained in FIG. 2 and/or FIG. 3, parallel processing units can operate on different data in the same clock cycle. Assuming, that the data, such as pixel data that can create a picture, is arranged sequentially in the memory each processing unit can load the data it operates on within one clock cycle as long as the number of processing units n is lower or equal to k.

Hence, the n processing units as one accessor group can, in an ideal case access n data segments in a single clock cycle. Moreover, as each control logic module can control m memory cells and m accessor groups can access the memory block in the same cycle, if they operate on different memory cells. Therefore, the higher the number m of memory cells 18030 that are controlled by one access control unit 18010 the higher is the chance, that memory accesses at this control unit will require access to a different memory cell. It can be appreciated that to operate at an increased efficiency m is higher or at least equal to y.

As explained above, the control logic modules 18010 can control access to the memory cells 18030 associated to them. Each control module can allow one accessor per memory cell in one clock cycle utilizing various methods of prioritization. Therefore, the system is designed to and has a high likelihood of allocating t he memory requests from all accessors in a single clock cycle to different memory cells. This memory allocation scheme can provide improved results when different accessors, or accessor groups, access different memory areas where the memory areas or cells are broken into locations having specific address ranges. As an example, if the processing units 110 shown in FIG. 5 access the memory address range 0 to n-1 and the DMA controller 130 accesses the address range n to p-1, the requests of both accessor groups (the processing units and the DMA controller) can be handled in parallel as the request is being made for different memory cells. Therefore, the shown address scheme applied on the shown apparatus allows parallel access to adjacent memory addresses as they go to different control logic modules and parallel access to certain memory address ranges as they can go to different memory cells even if they go to the same control logic unit.

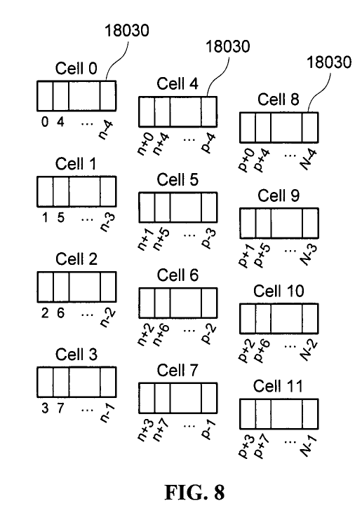

FIG. 8 shows a possible addressing scheme for the memory block 18020 of the embodiment shown in FIG. 6. However, as it has been mentioned before, m does not necessarily have to be equal to y and can be, e.g., higher than y. Therefore, in other embodiments, the addressing scheme shown in FIG. 8 can also be applied for memory cell modules facilitating two accessor groups as it is shown in FIG. 5. Again, in FIG. 8 address 0 is in Cell 0, address 1 in Cell 1, address 2 in Cell 2, address 3 in Cell 3, address 4 again in Cell 0, address 5 in Cell 6, and so on. The memory cells 18030 labeled “Cell 0”, “Cell 1”, “Cell 2”, and “Cell 3” can in this embodiment form the address range 0 to n-1, the memory cells 18030 labeled “Cell 4”, “Cell 5”, “Cell 6”, and “Cell 7” can form the address range n to p-1, and the memory cells 18030 labeled “Cell 8”, “Cell 9”, “Cell 10”, and “Cell 11” can form the address range p to N-1.

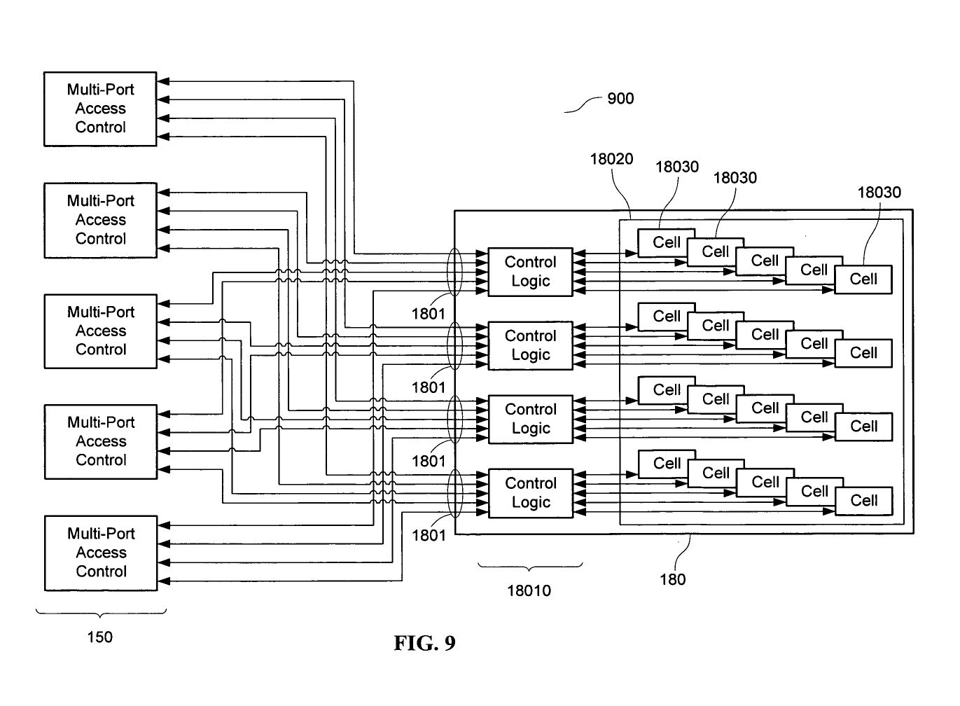

FIG. 9 shows another embodiment of the disclosure with four (k=4) ports and five (y=5) multi-port access control modules 150 and five (m=5) memory cells 18030 per control logic module 18010. Each multi-port access control modules 150 can serve an arbitrary number of accessors that access the memory cell module 180.

Each process disclosed herein can be implemented with a software program. The software programs described herein may be operated on any type of computer, such as personal computer, server, etc. Any programs may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet, intranet or other networks. Such signal-bearing media, when carrying computer-readable instructions that direct the functions of the present disclosure, represent embodiments of the present disclosure.

The disclosed embodiments can take the form of an entirely hardware embodiment, an entirely software embodiment or an embodiment containing both hardware and software elements. In one embodiment, the arrangements can be implemented in software, which includes but is not limited to firmware, resident software, microcode, etc. Furthermore, the disclosure can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The control module can retrieve instructions from an electronic storage medium. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD. A data processing system suitable for storing and/or executing program code can include at least one processor, logic, or a state machine coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

It will be apparent to those skilled in the art having the benefit of this disclosure that the present disclosure contemplates methods, systems, and media that can efficiently store and retrieve data from memory. It is understood that the form of the arrangements shown and described in the detailed description and the drawings are to be taken merely as examples. It is intended that the following claims be interpreted broadly to embrace all the variations of the example embodiments disclosed.

What is claimed is:

1. A memory system comprising:
a first requestor group;
a first access control module coupled to the first requester group to receive access requests from the first requester group;
a second requester group;
a second access control module coupled to the second requestor group to receive access requests from the second requestor group;
a controller module coupled to the first and second access control module to prioritize the access requests from the first and second requestor group; and
memory coupled to the controller module, the memory segmented into a plurality of address blocks, the plurality of address blocks having an address range wherein the controller sequentially rotates write access among the plurality of address blocks to distribute sequential data among the plurality of address blocks such that adjacent data of the sequential data to be placed a predetermined number of address locations apart.

2. The memory system of claim 1, wherein the controller module controls a single access per clock cycle to an address block in the plurality of address blocks.

3. The memory system of claim 1, wherein at least one address block is written to by the first requester group when the at least one address block is unrequested by the second requestor group.

4. The memory system of claim 1, wherein there are (a maximum) of m requestor groups each requestor group comprises k accessors and wherein there are k access control modules, and wherein each of the k accessors are coupled to one of the k access control modules, and wherein each of the k access control modules controls the access to m address blocks, and the memory has k*m address blocks.

5. The memory system of claim 1, wherein the address ranges are arranged in m columns and k rows.

6. The memory system of claim 5, wherein the m columns are of substantially the same size.

7. The memory system of claim 5, wherein the size of the m columns form the address range of the memory.

8. The memory system of claim 1, wherein the control logic modules prioritizes access requests of a first accessor group over access requests the second group of accessors.

9. The memory system of claim 8, wherein the controller module is comprised of a plurality of control logic modules where each control logic module is assigned to control a row of memory cells, each control logic module allowing one cell of the row to be exclusively accessed by an accessor during a clock cycle.

10. The memory system of claim 1, wherein the memory is comprised of cells and the m requestor groups comprise a plurality of requestors and k*m cells to be accessed concurrently by k*m accessors.

11. The memory system of claim 1, wherein the control logic modules prioritize read access requests over write access requests.

12. The memory system of claim 1, wherein the first requestor group to request a first memory access from a first memory block and wherein the second requester group to request second memory access from a second memory block and wherein the first and second memory access requests are processed concurrently.

13. A method of controlling memory comprising:
segmenting a memory into a plurality of address ranges;
accepting requests from a plurality of requestors, the requests to store a data stream where the stream has consecutive segments;
parsing the stream into the consecutive segments; and
storing the consecutive segments by rotating the address ranges utilized to store the consecutive segments.

14. The method of claim 13, further comprising prioritizing the storage requests based on a requestor group that has issued the request.

15. The method of claim 13, further comprising operating the plurality of requesters utilizing a same instruction multiple data configuration.

16. The method of claim 13, further comprising detecting when a segment of addresses will be in use by an accessor and controlling accesses to the memory based on the detection.

17. A computer program product comprising a computer useable medium having a computer readable medium, wherein the computer readable medium when executed on a computer causes the computer to:
segment a memory into a plurality of address blocks wherein blocks have an address range;
accept requests from a plurality of requestors, the requests to access sequential data;
parse the sequential data into segments; and
store the segments by sequentially rotating the use of address blocks.

18. The computer program product of claim 17, further comprising a computer readable medium when executed on a computer causes the computer to prioritize the storage requests based on an accessor group.

19. The computer program product of claim 17, further comprising a computer readable medium when executed on a computer causes the computer to detect when a segment of addresses will be in use by a requester and to control accesses to the memory based on the detection.

20. The computer program product of claim 17, further comprising a computer readable medium when executed on a computer causes the computer to separate memory accesses of a first requestor that go to a first memory block from memory accesses of a second requestor that go to a second memory block, the first and the second requestor being requesters of the plurality of k*m requesters, the blocks being blocks of the plurality of k*m blocks, the blocks arranged in k rows and m columns.
